(19) United States
(12) Patent Application Publication
(10) Pub. No.: US 2007/0096931 A1
(43) Pub. Date: May 3, 2007

(54) Alarm device

(76) Inventors: Dunstan Walter Runciman, ZEEKOEIVLEI (ZA); Colin William Peter Attwell, Parkland (ZA)

Correspondence Address: GENERAL ELECTRIC CO.;GLOBAL PATENT OPERATION, 187 Danbury Road, Suite 204, Wilton, CT, 06897-4122, US

(21) Appl. No.: 10/596,719

(22) PCT Filed: Dec. 21, 2004
(86) PCT No.: PCT/ZA04/00161

§ 371 Date: Oct. 10, 2006

(30) Foreign Application Priority Data
Dec. 22, 2003 (ZA) 2003/9884

(51) Int. Cl. G08B 17/10; G08B 3/00

(52) U.S. Cl. 340/628; 340/691.1

(57) ABSTRACT

An alarm device is disclosed for use with a fire detector which emits a visual or audible signal having recognisable characteristics. The signal is picked up by the alarm device which includes discriminating circuitry can recognise the signal. The device further includes a sound bomb which is activated upon a recognised signal being picked up. In a fire alarm installation there can be a series of alarm devices each of which recognises the signal of another alarm device whereby a number of alarm devices are activated in sequence.

### FIELD OF THE INVENTION

THIS INVENTION relates to an alarm device.

### BACKGROUND TO THE INVENTION

A variety of inexpensive stand alone fire detectors exist for domestic use. These are usually installed on ceilings, are battery powered, equipped with a light emitting diode (LED) indicator and have a limited audio output. The problems with these fire detectors are that they are not always loud enough to awaken sleeping children or guardians in rooms adjacent an emergency situation such as a fire, they are generally not able to awaken or alert hearing or sight impaired persons in emergency situations such as a fire and they do not provide any information to direct anyone to a safe exit in emergency situations such as a fire.

In a domestic fire emergency situation there is a need to awaken and alert sleeping occupants or to alert visually or aurally impaired occupants. In a domestic environment this is required to be accomplished at as low a cost as possible and with a means which is simple and easy to install. Applicant believes that the invention meets this need by, for example, adding low cost components to an existing fire detection system and at the same time adding the capability of directing the occupants towards a safe exit.

### BRIEF DESCRIPTION OF THE INVENTION

According to one aspect of the present invention there is provided an alarm device for use with a fire detector or fire detection system which emits an audible or visual alarm signal on detecting a fire condition, the device including discriminating means for recognising the pattern of the alarm signal and for activating a sound bomb upon recognition of an alarm signal.

The device can include means which enable it to learn the pattern of the signal which it must recognise.

Further according to the invention the alarm device may include a light emitting means such as, for example, a strobe light.

The alarm device may include a recording and playback means on which a message can be recorded and means for actuating the recording and play back means upon the sound bomb being activated whereby the message is played.

According to a further aspect of the present invention there is provided a fire alarm installation which comprises a fire detector having means for emitting, upon a fire situation being detected, an audible or visible signal having a signal pattern, and an alarm device including discriminating means for recognising said pattern, a sound bomb, and means for activating the sound bomb upon said discriminating means detecting said signal pattern.

According to another aspect of the present invention there is provided a fire alarm installation which comprises a fire detector having means for emitting, upon a fire situation being detected, an audible or visible signal having recognisable characteristics, and an alarm device including discriminating means for recognising said characteristics, a sound bomb, and means for activating the sound bomb upon said discriminating means detecting a signal with said recognisable characteristics.

According to a still further aspect of the present invention there is provided a fire alarm installation which comprises a fire detector having means for emitting, upon a fire situation being detected, an audible or visible signal having recognisable characteristics, a first alarm device including discriminating means for recognising said characteristics and emitting its own signal having recognisable characteristics, and a second alarm device, the second alarm device having discriminating means for recognising the characteristics of the signal of the first alarm device whereby the second alarm device is activated by the signal of the first alarm device.

### DETAILED DESCRIPTION OF THE INVENTION

An alarm device according to the invention will now be described in detail. The alarm device is provided for use with an existing domestic fire detector or detection system located in, for example, a house, a building housing people or a set of buildings housing people. The alarm device includes a housing which is located remote from and not linked to the fire detector or detection system. The alarm device is installed and operates independently of the existing fire detection system and there is no wiring between them. A sounder in the form of a “sound bomb” is located in the housing of the device. In one embodiment of the invention the sound bomb comprises one or more piezo-electric diaphragms mounted in a Helmhotz resonator chamber with a high volume output. The sound level is high, being at or near the threshold of pain, so as to ensure that the occupants are awakened by the alarm device.

The alarm device includes a microphone and discriminator circuitry so that the sounder is activated by a pre-learned sound pattern which emanates from the existing fire detector or detection system. The alarm device is taught to recognise its associated fire detector's sound signature upon its installation. The device is set to “learn” mode and then the existing fire detector to which the alarm device is to be responsive is activated using its test mode. The detector is allowed to sound for a period of time sufficient for the alarm device to register that it has “learnt” the sound signature. The alarm device is then switched to normal mode and the alarm device may then be tested for correct operation by again triggering the existing fire detector using its test mode. The alarm device, if the learning has been successful, will then operate. A small reset switch or link on the alarm device silences it and then returns it to the armed state. The alarm device may be tested periodically by activating in test mode the existing fire detector to which it is responsive.

The discriminator circuitry may function by using pattern recognition techniques or it may make sample comparisons to stored sound signatures so as to reduce the likelihood of false activations arising from ambient noise conditions such as, for example, television, radio or vehicle noises. The mode of operation of the discriminatory function of the alarm device can be based on detection of sound fundamentals and harmonics, resonances and mark-space timing.

Other activating methods which may be used by the alarm device include, for example, optical methods which make use of the strobe output of a existing fire detector system in the house combined with a fast-rise time edge detector to eliminate any false readings from other light sources and the use of dual tone multi-frequency (DTMF) signalling from the sender unit of the existing fire detector system.

In all forms the signal emitted, whether visual or audible, has recognisable characteristics, and the discriminator circuitry is tuned to, or “taught” to recognise, the signal to which it must respond.

The alarm device is preferably installed in close proximity to the sleeping location of an occupant of the house such as, for example, at the head of a bed, on a wall in a bedroom or on a bedside table.

The alarm device may further include a recording and playback means on which a message is recorded and played back after the sounder has been activated. The message can be a low volume voice message by someone such as, for example, the mother of a child if the alarm device is installed in the room of the child. The message is activated upon the sounder being activated so as to sooth the child and the message may also include the mother's voice giving instructions to the child on what to do and how to exit the house in the case of an emergency.

The alarm device may further include a light emitting means such as, for example, a high intensity Xenon strobe light or a high intensity light emitting diode (LED). The strobe light or LED indicates the proximity of an escape route or exit away from the fire. There may be more than one strobe light or LED included in the alarm device, with the position on the device or colour of the specifically activated strobe light or LED indicating the direction away from the fire and therefore the best direction to use for an escape route or exit.

The duration of activation of the sound and light functions of the alarm device is limited to a short time such as, for example, fifteen minutes.

The alarm device further includes a battery which is replaceable and a battery power monitor circuit which alerts the occupants of the house via an LED when the battery power is low and needs to be re-charged or replaced.

A series of alarm devices may be provided. All the alarm devices include a sounder and each alarm device “learns” the sound pattern of another device. All the alarm devices include a light emitting means such as, for example, a high intensity Xenon strobe light or a high intensity LED, and also indicate the proximity of an escape route away from the fire detected by the existing fire detection system.

An alarm device which monitors an exit may include a heat detector which prevents activation of the device by the learned sound of another alarm device if dangerous heat levels are detected. The dangerous situation may be indicated by activating a red coloured LED or strobe as opposed to activating a green coloured LED when there is no dangerous situation.

A fire detected by the fire detector or fire detection system causes a specific sound pattern to be emitted, that sound pattern activates a first alarm device, the sound emitted by the first alarm device activates a second alarm device and so on. This thus causes a sound cascading effect in which multiple alarm devices located at various positions throughout the house are triggered to activate from a single source of fire detected by the existing fire detector or detection system. This provides a means to evacuate all the occupants in the house to safety timeously and via the safest escape routes or exits. These safe escape routes or exits may be indicated to be to one side of the house, away from the side of the house in which a fire has been detected or the safe escape routes or exits may be indicated radially away from a central point in the house if the fire has been detected at a central point in the house.

1. An alarm device for use with a fire detector or fire detection system which emits an audible or visual alarm signal on detecting a fire condition, the device including discriminating means for recognising the alarm signal and for activating a sound bomb upon recognition of an alarm signal.

2. An alarm device as claimed in claim 1 and which includes means which enable it to learn the characteristics of the signal which it must recognise.

3. An alarm device as claimed in claim 1 and which includes a light emitting means.

4. An alarm device as claimed in claim 3, wherein the light emitting means is a strobe light.

5. An alarm device as claimed in claim 1 and further comprising a recording and playback means on which a message can be recorded and means for actuating the recording and playback means upon the sound bomb being activated so that the message is played.

6. A fire alarm installation which comprises a fire detector having means for emitting, upon a fire situation being detected, an audible or visible signal having recognisable characteristics, and an alarm device including discriminating means for recognising said characteristics, a sound bomb, and means for activating the sound bomb upon said discriminating means detecting a signal with said recognisable characteristics.

7. A fire alarm installation which comprises a fire detector having means for emitting, upon a fire situation being detected, an audible or visible signal having recognisable characteristics, a first alarm device including discriminating means for recognising said characteristics and emitting its own signal having recognizable characteristics, and a second alarm device, the second alarm device having discriminating means for recognising the characteristics of the signal of the first alarm device whereby the second alarm device is activated by the signal of the first alarm device.

8. An alarm device as claimed in claim 2 and which includes a light emitting means.
